(19) United States
(12) Patent Application Publication
(10) Pub. No.: US 2008/0096061 A1
(43) Pub. Date: Apr. 24, 2008

(54) Metal-Air Battery or Fuel Cell

(75) Inventor: Trygve Burchardt, Staefa (CH)

Correspondence Address: ROTHWELL, FIGG, ERNST & MANBECK, P.C., 1425 K STREET, N.W., SUITE 800, WASHINGTON, DC, 20005, US

(73) Assignee: REVOLT TECHNOLOGY LTD, Dublin (IE)

(21) Appl. No.: 11/761,032

(22) Filed: Jun. 11, 2007

Related U.S. Application Data
(60) Provisional application No. 60/812,603, filed on Jun. 12, 2006.

(51) Int. Cl. H01M 8/02

(52) U.S. Cl. 429/13; 429/29; 29/623.1; 429/27

(57) ABSTRACT

A metal-air battery or fuel cell comprising a metal or metal hydride anode, an aqueous liquid electrolyte containing an ion conducting material, and an air electrode which allows ingress and egress of oxygen and which contains one or more catalysts capable of evolution and/or reduction of oxygen, wherein the air electrode has both hydrophobic and hydrophilic pores, the hydrophilic pores are at least partially filled with aqueous liquid electrolyte and the air electrode and/or the electrolyte comprises hygroscopic material and OH⁻ ions, whereby water vapour exchange with the environment is limited. The hygroscopic material is used to control the humidity of the system.

### FIELD OF THE INVENTION

The present invention relates to water management in a metal-air battery or fuel cell containing an air electrode. In particular the invention relates to the use of hygroscopic materials to control the humidity of the battery system.

### BACKGROUND OF THE INVENTION

### Fuel Cells

The large demand for new energy storage systems has resulted in extensive research and development in batteries and fuel cell. For large systems (power levels in the kW range) the main driving force is on environmental aspects. Energy conversion and storage at high efficiency and with non-polluting chemicals is essential. For smaller systems (power levels in the W range), the increased demands from the consumer electronics market push the development. New applications are emerging that put constraints on existing battery systems opening the market for new energy solutions.

During the last 10-15 years, a lot of effort has been put into fuel cells to provide a solution to future energy demands. However, many major challenges are still faced, such as cost reduction, volumetric energy density and the need for size consuming peripheral systems.

Fuel cells convert chemical energy of a fuel into electrical energy. Unlike batteries, the reactants are continuously fed from an external source. The most typical fuel cell reactions are the oxidation of hydrogen at the anode and the reduction of oxygen from air at the cathode.

For alkaline fuel cells, the air electrode is usually made from thin porous PTFE bonded carbon layers. Within the electrode a double pore structure exists. Hydrophobic pores are used to enable high rates of oxygen diffusion. A hydrophilic pore structure of narrow pores enables penetration of the electrolyte by capillary forces. The reduction of oxygen takes place on catalyst particles in the 3-phase boundary within the electrode.

Facing the air side of the electrode a hydrophobic backing layer prevents any liquid penetration. With proper construction of the electrode, only gas interactions will occur between the interior and the exterior of the system. In order to maintain a stable liquid balance the water vapour interaction with the environment has to be controlled. With low humidity (<45% RH) of the surroundings a drying out of the electrolyte occurs. With high humidity (>45% RH) flooding of the electrode might occur. Drying out or flooding of the system results in increased ohmic resistance and subsequently a loss in the power density and efficiency of the fuel cell. With long time exposure in dry environments, the electrode can dry out completely causing irreversible system failure.

The management of the electrolyte in a fuel cell system has been addressed in many patents and publications. To a large extent the solutions that have been proposed relate to the peripheral system specifications. When air is used on the cathode side, the humidity of the air entering and leaving the fuel cell influences the water balance within the system. Fuel cells produce water and the excess water must be removed from the system in order not to flood the system. To operate the system with high stability the air humidity must be balanced against the water production within the fuel cell. This can be managed by an electrolyte circulation system or a pre-treatment of the access air into the fuel cell in order to control the humidity of the air.

On the other hand, for most battery systems the influence of the humidity in the environment is minimal as they are operated in a closed environment. The drawback is that it is difficult to adjust the system if an unstable situation occurs. Therefore, any unwanted side reactions (such as water formation or removal reactions) will have to be minimised in order not to affect the electrolyte. A fuel cell is thus a more dynamic system; monitoring and adjusting the water balance can be done by peripheral systems. Batteries on the other hand, are more compact and less costly.

Metal-Air Batteries

The metal-air battery system combines properties from both fuel cell and battery technology. An air electrode is used for the cathode. This enables an unlimited source of reactants for the cathode within a thin layer (300-700 μm). For the anode a metal with high energy density per weight and volume is used. Metals such as Zn, Al, Mg, Fe and Li are suitable anode materials. The benefit of the metal-air system is the high energy capacity. A rechargeable metal-air system is enabled by the development of bifunctional air electrodes and the use of rechargeable anode materials.

A metal-air battery system is a partially open system where the air electrode interacts with the environment. A method to prevent dry-out or flooding caused by the humidity of air must thus be implemented under certain conditions. It has been shown that if the humidity is below 45% the battery may slowly dry-out and that if the humidity is above 45% the system may be flooded. The applications for this technology are thus limited by the influence of the humidity.

Metal-air batteries are commercially available only as primary zinc-air button cell batteries. These batteries have a long shelf life due to the closed air access packaging. When in use the surrounding environmental conditions cause a slow deactivation of the battery. The lifetime is thus limited by the environmental influence. Due to these constraints only a small part of the button cell size battery market is available for these batteries. The main limitation for applying it in a larger share of the market is the limited current density and the low stand-by time available.

Anode materials such as Zn, Al, Mg, Fe and Li have often been proposed in the literature for primary or refillable metal-air batteries. For rechargeable batteries, there are difficulties in recharging such anodes due to shape changes and dendrite formation.

An alternative approach is the use of metal-hydride materials as the anode. Metal-hydrides are used in rechargeable nickel/metal-hydride batteries with high stability (typically 500-600 cycles are shown). Another rechargeable anode material is Cd, however this material is somewhat restricted due to the environmental aspects.

The prior art discloses primarily polymers and resins for use as water absorbing constituents in batteries and fuel cells. Use has also been made of metal oxides and carbon particles. However, polymerisation has the disadvantage that it becomes difficult to lead trapped gas out of the electrolyte. Further, the method of polymerisation only reduces water loss from the electrolyte, which means that there is still too much water loss compared to the required lifetime of most battery or fuel cell applications.

DE 19917812 is directed to a membrane-electrode unit for a self-humidifying fuel cell battery. In addition to a catalyst layer this electrode unit also comprises hygroscopic particles, such as ZrO₂, SiO₂ and/or TiO₂ which serve to retain the water.

JP 2004152571 to Honda Motor Corp. discloses an electrode structure for a solid polymer fuel cell. It describes a layer made of carbon particles and fluoroplastic having a moisture absorption rate of not less than 150 cc/g.

U.S. Pat. Nos. 5,652,043 and 5,897,522 describe an open electrochemical cell. The cell comprises three layers: an insoluble anode layer and an insoluble cathode layer separated by an electrolyte layer that includes deliquescent material, an electroactive soluble material for ionic conductivity and a water-soluble polymer for adhering the layers together. These patents do not relate to batteries having an air electrode, i.e. metal-air batteries or fuel cells, but instead relate to “classical” batteries such as zinc-manganese batteries. The teaching of these patents is not relevant to metal-air batteries or fuel cells because insoluble electrodes cannot be used for the cathode, since it requires liquid and gas penetration into the three-phase boundary. An electrolyte with an adhering material as described in these patents also is not suitable for use in metal-air batteries or fuel cells because it limits the absorption of electrolyte into the air electrode, thus resulting in a low reaction rate. In addition any gelling agents within the electrolyte will result in gas being trapped inside the electrolyte resulting in low surface area contact between the electrolyte and the electrodes.

In US patent applications 2005/0255339 and 2002/0177036 a metal-air cell with an exchangeable anode is disclosed. To enable the exchange procedure a conductive separator is proposed which consists of KOH, a polymeric material such as PVC or PEO, and a small addition of CaCl₂ as hygroscopic agent. The separator has the form of a membrane or thick film with a thickness below 1 mm. The ionically conductive materials are thus integrated in a self-supporting solid structure and having such a solid structure in the electrolyte of a metal-air battery with an air electrode as described below would hinder gas exchange.

It is known that for fuel cells which use oxygen as oxidant one can enhance the power output if one adds salts such as halides or acetates of the alkali or alkaline earth metals, amongst others, to an alkali metal hydroxide containing electrolyte (cf. U.S. Pat. No. 3,316,126). The function of these salts is to enhance the ionic conductivity of the electrolyte. As this type of fuel cell, in contrast to the present invention, has an external circulation of electrolyte, the composition of the electrolyte can be adjusted easily and there is no need to use additives with hygroscopic properties in the electrolyte for this purpose.

U.S. Pat. No. 5,302,475 discloses a rechargeable zinc cell comprising an aqueous alkaline electrolyte containing KOH and a defined combination of KF and K₂CO₃ salts with the aim of reducing shape changes and dendrite formation of the zinc electrode which constitutes a problem for the stability of secondary zinc batteries. It is known to those skilled in the art that it is possible to reduce the solubility of zinc species formed during discharge if one exchanges a part of the OH⁻ ions with other anions and the method described appears to be based on this effect. However, the method is not concerned with any kind of humidity management in a metal-air cell which is to be effective at the interface between the liquid electrolyte and the air, i.e. inside the pores of the air electrode.

French patent 2 835 656 discloses an ionically conductive layer placed next to the air electrode of a metal-air battery which layer consists of an anion exchanger material containing mobile OH⁻ ions. The anion exchanger material inhibits the migration of carbonate ions into the electrolyte and the formation of hardly soluble sodium carbonate. The presence of this layer does not affect the water balance of the metal-air battery.

In order to prevent drying out of metal-air batteries, three methods are in principle possible.
1. The use of peripheral systems, such as oxygen humidifier. This involves treatment of the air before it enters the system in order to control the humidity. The drawback with this method is the increased size and cost of the battery.
2. The use of a selective membrane, which is a membrane that reduces water vapour transport, but allows oxygen transport. Such membranes will slow down water vapour transport, but also limit oxygen transport resulting in low currents for the system.
3. The use of a modified electrolyte. Earlier attempts to slow down the drying of the cell by modifying the electrolyte have involved polymerisation of the electrolyte, thus trapping water within the electrolyte and reducing the loss of humidity. However, as described above polymerisation leads to trapped gas in the electrolyte and does not reduce water loss to the extent required compared to the lifetime of most battery or fuel cell applications.

An object of the present invention is to provide an alternative solution to the problem of water management in metal-air battery systems and fuel cells. A further object of the invention is to provide a passive state small battery system having an air electrode, which requires no peripherals (e.g. pumps, humidity controls, etc). “Passive state” refers to the idea that the system is stable without the need for external controls. The system is stable in that it is resistant to flooding or drying out caused by environmental interactions through the air electrode.

### SUMMARY OF THE INVENTION

According to one aspect, the invention provides a metal-air battery or fuel cell comprising a metal or metal hydride anode, an aqueous liquid electrolyte containing an ion conducting material, and an air electrode which allows ingress and egress of oxygen and which contains one or more catalysts capable of evolution and/or reduction of oxygen, wherein the air electrode has both hydrophobic and hydrophilic pores, the hydrophilic pores are at least partially filled with aqueous liquid electrolyte and the air electrode and/or the electrolyte comprises hygroscopic material and OH⁻ ions, whereby water vapour exchange with the environment is limited. Surprisingly, the presence of a hygroscopic material balances the system and stabilises it by preventing it from flooding or drying out. This is in contrast to what was expected because some of the hygroscopic materials used according to the invention are strongly hygroscopic and some are even deliquescent thus forming a solution when exposed to atmospheric moisture. However, no flooding of the electrodes was observed when using such materials according to the invention. The OH⁻ ions increase conductivity.

Preferably, the hygroscopic material comprises CaBr₂, K₃PO₄, CH₃COOK, K₂CO₃, K₂HPO₄, KH₂PO₄, Na₂SO₄, MgSO₄, P₄O₁₀, CaO, CaCl₂, or combinations thereof. The OH⁻ ions may in the form of NaOH, KOH and/or LiOH, and are preferably in the form of NaOH or LiOH.

According to one embodiment the hygroscopic material and OH⁻ ions are in the electrolyte. Most preferably, the electrolyte comprises CaBr₂ as hygroscopic material and OH⁻ ions in the form of NaOH. The electrolyte may contain varying proportions of CaBr₂ and NaOH, but most preferably the weight ratio of CaBr₂ to NaOH is between 4:1 and 1:2. According to one embodiment the weight ratio is 1:1.

According to another embodiment the hygroscopic material and OH⁻ ions are in the air electrode. Most preferably, the air electrode comprises CaBr₂ as hygroscopic material and OH⁻ ions in the form of NaOH. The air electrode may contain varying proportions of CaBr₂ and NaOH, but most preferably the weight ratio of CaBr₂ to NaOH is between 4:1 and 1:2. According to one embodiment the weight ratio is 1:1.

The hydrophilic pores are pores situated within an activated carbon or graphite material or a combination thereof, whilst the hydrophobic pores are rendered hydrophobic by a complete or partial coating of the walls of the pores with PTFE or other polymers such as polyolefins, e.g. polyethylene (PE), polypropylene (PP), polyisobutylene (PIB), thermoplastics such as polybutylene terephthalate (PBT) or polyamides, polyvinylidene fluoride (PVDF), silicone-based elastomers such as polydimethyl siloxane (PDMS) or rubber materials such as natural rubber (NR), ethylene propylene rubber (EPM) or ethylene propylene diene monomer rubber (EPDM), or combinations thereof.

The battery may be a button cell, a cylindrical cell or a prismatic cell. The battery may be a primary battery or a secondary battery, but is preferably a secondary battery.

According to a further aspect, the invention provides the use of a hygroscopic material and OH⁻ ions in the air electrode and/or the electrolyte of a metal-air battery or fuel cell system to control the humidity of the system. Preferably, the air electrode has both hydrophobic and hydrophilic pores and contains one or more catalysts capable of evolution and/or reduction of oxygen and the air electrode and/or the electrolyte contains OH⁻ ions and a hygroscopic material and the hydrophilic pores are at least partially filled with electrolyte. Other preferable features are as described above.

According to a further aspect, the invention provides a method for controlling the humidity of a metal-air battery or fuel cell system comprising a metal or metal hydride anode, an aqueous liquid electrolyte and an air electrode that takes oxygen from the environment as cathode, which comprises providing hygroscopic material and OH⁻ ions in the air electrode and/or the electrolyte.

According to a further aspect, the invention provides a method for the dry assembly of a metal-air battery or fuel cell comprising an air electrode that takes oxygen from the environment as cathode, a metal or metal hydride anode, and an electrolyte, said method comprising assembling the cathode, anode and a dry powder mixture of hygroscopic material and a source of OH⁻ ions to form the battery and allowing the powder mixture to self-activate by absorbing water from the air thereby forming an ionic conductive aqueous electrolyte.

In this method the metal-air battery or fuel cell is preferably as described above.

According to a further aspect, the invention provides a method for the wet assembly of a metal-air battery or fuel cell comprising an air electrode that takes oxygen from the environment as cathode, a metal or metal hydride anode, and an electrolyte, which comprises the steps of:
dissolving a hygroscopic powder in an aqueous solution containing OH⁻ ions to form an electrolyte solution;
adjusting the pH of the electrolyte solution such that it is equivalent to an alkaline solution with a 2-12 M OH⁻; and
assembling the cathode, anode and electrolyte solution to form the battery. Preferably the pH of the electrolyte solution is equivalent to an alkaline solution with a 4-10 M OH⁻, most preferably 4 to 6.6 M OH⁻. In this method the metal-air battery or fuel cell is preferably as described above.

According to a further aspect, the invention provides a method for reactivating a dry metal-air battery or fuel cell comprising an air electrode that takes oxygen from the environment as cathode, a metal or metal hydride anode, and an electrolyte comprising hygroscopic material and OH⁻ ions, said method comprising exposing the battery to a humid environment whereby the dry electrolyte self-activates by absorbing water from the air thereby forming an ionic conductive aqueous electrolyte.

In this method the metal-air battery or fuel cell is preferably as described above.

According to further aspects, the invention provides a metal-air battery or fuel cell comprising an air electrode that takes oxygen from the environment as cathode, a metal or metal hydride anode, and an electrolyte, wherein the electrolyte and/or the air electrode comprises CaBr₂ as hygroscopic material and NaOH as a source of OH⁻ ions. The electrolyte and/or the air electrode may contain varying proportions of CaBr₂ and NaOH, but most preferably the weight ratio of CaBr₂ to NaOH is between 4:1 and 1:2. According to one embodiment the weight ratio is 1:1.

### BRIEF DESCRIPTION OF THE DRAWINGS

FIG. 1 shows the weight increase for the hygroscopic materials CH₃COOK, K₂CO₃ and CaBr₂ as a function of time. The powders have been left in ambient atmosphere for about 3000 hours. The experiment was performed at a mean temperature of 25° C. and mean relative humidity of 30%.

FIG. 2 shows the open circuit potential for cells with two different aqueous electrolytes, KOH and NaOH, as a function of time. The experiment was carried out at 25° C. and 30% humidity.

FIG. 3 shows the increase in weight for the dry mixture of NaOH (20%) and hygroscopic material CaBr₂ (80%), compared to the weight loss in a standard electrolyte, KOH (6M). During testing the relative humidity was in the range 20-30% and the temperature 25° C.

FIG. 4 shows the weight loss with time for the wet mixtures of 0.5 g CaBr₂ in 10.0 g KOH and 0.5 g CaBr₂ in 10.0 g NaOH. During the experiment the samples were left in ambient air. The temperature was in the range 20-30° C. and the mean humidity was 30%.

FIG. 5 shows the weight and open circuit potential of a button cell with electrolyte of wet powders, a 50:50 mixture of CaBr₂ and NaOH dissolved in water, as a function of time. The experiment was performed at two different temperature and humidity intervals:

1) 15% relative humidity and 80° C.

2) 25% relative humidity and 25° C.

FIG. 6 shows weight and open circuit potential of a button cell with electrolyte of dry powders, a 50:50 mixture of K₃PO₄ and NaOH, as a function of time. The experiment was performed at two different temperature and humidity intervals:

1) 15% relative humidity and 80° C.

2) 25% relative humidity and 25° C.

FIG. 7 shows the potential of a wet assembled button cell with a 50:50 powder mixture of NaOH and CaBr₂ dissolved in water as electrolyte. The experiment was performed at low current, 0.16 mA for 1000 hours

FIG. 8 shows the polarisation curve for an air electrode with a 50:50 mixture of CaBr₂ and NaOH in water as catalyst.

FIG. 9a shows a prismatic cell design.

FIG. 9b shows a part of the cell in larger scale, illustrating the battery case (91), Zn-electrode (92) and air electrode with current collector (93).

FIG. 10 shows a button cell design, illustrating the battery case (101), Zn electrode (102), air electrode (103) and opening for air access (104).

### DETAILED DESCRIPTION OF THE INVENTION

The present invention relates to the introduction of a hygroscopic material to the alkaline electrolyte and/or the air electrode of a metal-air battery or fuel cell. Surprisingly such a battery shows a better stability when exposed to changes of the water vapour content of the environment. The invention makes it possible to keep the water within the system even in surroundings of low humidity and also prevents flooding of the system in surroundings of high humidity. In addition, the hygroscopic material will reactivate the electrode if exposed to low humidity over long time periods.

As used herein, the term “metal-air battery system” is intended to include any battery or fuel cell which contains an air electrode that takes oxygen from the environment as cathode. The anode electrode may be a metal, such as Cd, Al, Li, Fe and Mg, or a metal hydride. Examples of metals in metal hydride materials are the AB₅ or AB₂ structure types where the “ABₓ” designation refers to the ratio of A elements and B elements. For the AB₅ type, A is a combination of La, Ce, Pr and Nd and for the AB₂ type, A can be Ti, Zr or a combination of Ti and Zr. For both structure types, B is typically a combination of Ni, Mn, Co, Al and Fe.

Typical hygroscopic material are CaBr₂, K₃PO₄, CH₃COOK, K₂CO₃, K₂HPO₄, KH₂PO₄, Na₂SO₄, MgSO₄, P₄O₁₀, CaO, CaCl₂, but any hygroscopic material may be used in the context of this invention. Hygroscopic materials readily absorb and retain water. By measuring the weight increase of a powder when left in ambient air, the water absorption can be measured. Dry CaBr₂ powder was saturated with water after two days in ambient atmosphere and the increase in weight was almost 50%. K₃PO₄ and CH₃COOK also showed similar properties.

Described herein are electrolytes containing an ion conducting material such as OH ions which are preferably in the form of NaOH, KOH and/or LiOH. Also described are electrolytes having both water retaining properties and sufficient electrochemical properties for use in a metal-air battery or fuel cell. The above mentioned hygroscopic powders have the desired property of water retention, but the electrochemical activity and conductivity in solutions of these powders are poor. To increase the conductivity, OH⁻ ions, preferably in the form of NaOH, KOH and/or LiOH, are mixed with the hygroscopic material. The combined effect of these properties is higher with NaOH than with KOH.

A common feature of most fuel cells and all types of metal-air batteries is the air electrode (sometimes also called gas diffusion electrode). The most common air electrodes are based on a combination of a pore forming material, a binding agent and a catalyst or a combination of catalysts and possibly some other additives.

The pore forming material usually consists of an activated carbon material or graphite (both preferably with a BET surface area of more than 100 m².g⁻¹) or a combination thereof. Hydrophilic pores are present within these materials and they may also serve as a support for the catalyst(s).

The binder is used to increase the mechanical stability of the electrode and it causes the pores to become hydrophobic. The most common binder is PTFE, but other polymer materials may also be used. Suitable materials are PE, PP, PIB, thermoplastics such as PBT or polyamides, PVDF, silicone-based elastomers such as PDMS or rubber materials such as NR, EPM or EPDM, or combinations thereof.

A catalyst or a catalyst combination is generally introduced to improve the reaction rate of the oxygen reduction reaction. Very often catalytically active metals or oxygen-containing metal salts are used such as Pt, Pd, Ag, Co, Fe, MnO₂, KMnO₄, MnSO₄, SnO₂, Fe₂O₃, CoO, CO₃O₄, or others. A combination of more than one catalytically active material may also be used. In the case of a secondary battery with a bifunctional air electrode additional catalysts or catalyst combinations capable of evolving oxygen may be used additionally. Examples for such catalysts are materials like WC, TiC, CoWO₄, FeWO₄, NiS, WS₂, La₂O₃, Ag₂O, Ag, spinels (spinels are a group of oxides of general formula AB₂O₄, where A represents a divalent metal ion such as magnesium, iron, nickel, manganese and/or zinc and B represents trivalent metal ions such as aluminium, iron, chromium and/or manganese) and perovskites (perovskites are a group of oxides of general formula AXO₃, where A is a divalent metal ion such as cerium, calcium, sodium, strontium, lead and/or various rare earth metals, and X is a tetrahedral metal ion such as titanium, niobium and/or iron where all members of this group have the same basic structure with the XO₃ atoms forming a framework of interconnected octahedrons).

Usually an air electrode consists of two or more separate layers with different properties and a metal mesh (generally made from nickel or stainless steel) which is used as a current collector and which helps to stabilize the electrode.

Close to the air side of the electrode, a layer that allows gas penetration but prevents liquid penetration is used. This porous and hydrophobic layer is called the gas diffusion layer (GDL). Both the reduction and the oxygen evolution reaction take place in one or more layers closely bonded to this layer. For the oxygen reduction reaction, a layer which allows oxygen and electrolyte penetration to the reaction zone is required. This layer with a double pore structure of both hydrophobic and hydrophilic pores is called the active layer (AL). For the oxygen evolution reaction, a hydrophilic pore structure is required so as to allow sufficient electrolyte penetration into the reaction zone for oxygen evolution. These pores may be located within the AL but it may be advantageous to have a separate layer with a hydrophilic pore structure which is then called the oxygen evolution layer (OEL).

In general, an air electrode is created in a three-step process. Firstly one has to perform the mixing process for every layer separately. For this purpose the pore forming materials, the catalysts, the binding materials and other additives are mixed under the influence of mechanical, thermal or mechanical and thermal energy. In this process the materials have to be well distributed. If the mixture contains a hydrophobic binding agent then this binder forms a three dimensional network connecting the powders into an agglomerate. The mixture or the agglomerate is then extruded and/or calendared into a layer. Secondly, layers with different properties are combined by calendaring and/or pressing. Thirdly, the current collector is pressed or calendared into the combined layers.

In terms of the mixing step a differentiation is usually made between a “dry” process and a “wet” process.

In a “dry” process all of the ingredients of a layer are mixed together in the form of dry powders. In a “wet” process one or more solvents are added at the beginning or during the mixing process or alternatively one or more ingredients may be used in the form of a dispersion or suspension. The solvent(s) have to be removed directly after the mixing process or in a later state of the production process by some kind of heating or drying process.

It is also possible to combine both dry and wet processes for the different layers and the production may be performed in a continuous production line according to patent application WO 2005/004260, the disclosure of which is hereby incorporated by reference. In this patent application and the references therein one can find a detailed review of production methods for air electrodes.

In the GDL, the amount of binding agent is preferably from 5 to 50% by weight of the composition of the layer. The rest of the active layer preferably consists of a high surface area carbon and/or graphite material and possibly some other additives.

In the AL, the amount of binding agent is preferably between from 5 to 50% by weight of the composition of the layer and the amount of catalyst(s) is preferably from 2 to 30% by weight of the composition of the layer. The rest of the active layer preferably consists of a high surface area carbon and/or graphite material and possibly some other additives.

In the OEL, the amount of binding agent is preferably from 2 to 15% by weight of the composition of the layer and the amount of catalyst(s) is preferably from 25 to 65% by weight of the composition of the layer. The rest of the oxygen evolution layer preferably consists of a high surface area carbon and/or graphite material and possibly some other additives.

Every layer may be produced using either the dry or the wet process. When applying the dry process, usually PTFE with a particle size below 1 mm is used as a binder and an additional pore forming aid such as ammonium bicarbonate may be employed to create the GDL or the OEL. When applying the wet process, one may use a suspension of PTFE in water as a binder and a pore forming aid such as ammonium bicarbonate may be employed to create the OEL.

The following two examples are provided to illustrate the differences between the dry and the wet process.

Assembly Example 1 (Dry Process):

An active layer (AL) was prepared using 15 wt.-% PTFE as a powder with a particle size below 1 mm (Lawrence Industries), 70 wt.-% high surface area carbon (XC 500, Cabot) and 15 wt.-% of manganese sulfate (MnSO₄, Prolabo) as a catalyst. The binding agent, the pore forming agent and the catalyst were mixed together in a single-shaft rotary mixer at 1000 rpm to form a homogeneous mixture. The mixture was then heated to a temperature of 90° C. When the powder mixture reached the required temperature the powder was milled at 10000 rpm for 1 hour and an agglomerate was formed. This agglomerate was pressed into a brick of about 2 mm thickness and calendared into a sheet of about 0.5 mm thickness.

To create the gas diffusion layer (GLD), a mixture of 25 wt.-% PTFE with a particle size below 1 mm (Lawrence Industries) and 75 wt.-% of ammonium bicarbonate with a particle size below 10 μm (Aldrich) was mixed at a maximum temperature of 40° C. for 2 hours at 1500 rpm in a single-shaft rotary mixer. An agglomerate was formed that was pressed into a brick of about 2 mm thickness and calendared into a sheet of about 1 mm thickness.

The two layers were then calendared together to a total thickness of 0.8 mm. Finally, a nickel mesh current collector was pressed into the electrode at 80° C. and 70 bars. The electrode was then dried at 70° C. for 8 hours to create the hydrophobic porosity of the GDL and to remove the ammonium bicarbonate.

Assembly Example 2 (Wet Process):

An active layer (AL) was prepared using 15 wt.-% PTFE as a suspension containing 60 wt.-% PTFE dispersed in water (Aldrich), 65 wt.-% high surface area carbon (XC 500, Cabot) and 20 wt.-% of manganese sulfate (MnSO₄, Prolabo) as catalysts. As a first step, the high surface area carbon was mixed with both catalysts in water. Separately, a PTFE suspension was mixed with water. Then, the PTFE suspension was added to the carbon suspension and the materials were mixed and agglomerated to form a slurry. The slurry was then mixed in an ultrasonic bath for 30 minutes and subsequently dried at 300° C. for 3 hours to remove any surfactants. The dried mixture was then agglomerated and a hydrogen treated naphtha with low boiling point (Shellsol D40, Shell Chemicals) was added to form a paste and the paste was then calendared into a thin layer of about 0.8 mm thickness to form the active layer (AL).

A hydrophobic layer (GDL) was produced by the same method. In this layer only high surface area carbon (65 wt.-%) and PTFE (35 wt.-%) were used and the final thickness was 0.8 mm.

The two layers were then calendared together forming an electrode with a total thickness of 0.8 mm. Finally, a nickel mesh current collector was pressed into the electrode at 80° C. and 70 bars. The electrode was then dried at 70° C. for 12 hours to remove the organic solvent.

One embodiment of the invention includes the use of hygroscopic material(s) and a source of OH⁻ ions in the air electrode. With air electrodes prepared from dry powder materials the hygroscopic material(s) can be introduced into the powder mixture of the active layer. In particular, a powder including the hygroscopic material(s) already mentioned and the ion conducting powder(s) such as KOH, NaOH and/or LiOH may be mixed with the other powder ingredients. The hygroscopic powders should be thoroughly dried before they are mixed together with the other ingredients of the AL according to a procedure similar to the dry process described in assembly example 1. The total amount of hygroscopic material and alkaline hydroxide as well as their ratio may be freely varied according to the environmental conditions (range of relative humidity and temperature) to which a metal-air cell with an air electrode is intended to be exposed during operation. Preferably, the total amount of hygroscopic material and alkaline hydroxide together shall not exceed 20 wt.-% so as not to weaken the mechanical stability of the air electrode.

Another embodiment of the invention relates to the formation of a separate layer which consists mainly of hygroscopic material(s) and a source of OH⁻ ions. In particular, a powder including the hygroscopic material(s) already mentioned and the ion conducting powder(s) such as KOH, NaOH and/or LiOH may be mixed with a binder. Preferably the binder material is PTFE and the concentration range of the binder is between 5 wt.-% and 20 wt.-% to establish a sufficiently high mechanical stability for handling without reducing the ionic conductivity of the final electrode in which such a separate layer is to be introduced. This separate layer is pressed or calendared in a first step and then pressed or calendared together with an active layer in a second step and possibly subjected to some kind of heat treatment afterwards which will accelerate the migration of the components of the separate layer into the active layer. Depending on the degree of homogenisation the resulting active layer may have similar properties compared to an active layer which has been created with the above mentioned method of directly mixing all the ingredients.

With exposure to the environment the hygroscopic materials in both above mentioned embodiments absorb water resulting in a wetting of the active layer of the air electrode. A three phase boundary is thus obtained within the air electrode that can withstand changes to the humidity of the environment.

In one embodiment of the invention a dry powder mixture of hygroscopic material and a source of OH⁻ ions is placed in the cell in place of the electrolyte. This dry mixture will self activate by absorbing water from air, thereby forming an ionic conductive aqueous electrolyte. This allows a dry assembly of a metal-air battery. It also shows that a dry cell can be reactivated by exposure to a humid environment.

In another embodiment of the invention, a pre-wetted electrolyte is used. This involves dissolving a hygroscopic powder in an aqueous solution containing OH⁻ ions, preferably an aqueous solution of NaOH, KOH or LiOH. The pH of this solution can be varied. Preferably the pH of the solution should be equivalent to alkaline solution with a concentration of 2-12 M OH⁻, more preferably 4-10 M and most preferably 4-6.6 M. The electrolyte is filled into the battery case before the case is closed or sealed.

In a further embodiment of the invention the active layer (optionally with an oxygen evolution layer) is wetted with an aqueous mixture of hygroscopic material(s) and a source of OH⁻ ions. In particular, a powder including the hygroscopic material(s) already mentioned and the ion conducting powder(s) like KOH, NaOH and/or LiOH may be dissolved in water. The resulting wet mixture may be introduced into the active layer (and optionally into the oxygen evolution layer if this is present) by means of dip coating, spraying or soaking the mixture into the porous layer before combining the active layer with the gas diffusion layer and the assembly of the electrode. Additional electrolyte may be filled into the battery case before the case is closed or sealed.

Electrolytes of various compositions of hygroscopic material and OH⁻ source may be used in accordance with the invention. Tests done on different compositions of a mixture of NaOH and CaBr₂ powder showed that a very good humidity control in a metal-air cell operating at moderate conditions (i.e. a temperature range between 20 and 30° C. and a relative humidity between 20 and 50%) was obtained for a 1:1 mixture regarding the weight of NaOH and CaBr₂ in an aqueous electrolyte (which may be prepared by mixing 10 g CaBr₂ powder, 10 g NaOH powder and 15 ml of water).

However, the ratio of CaBr₂ to NaOH may be adjusted to the environmental conditions (range of relative humidity and temperature) to which a metal-air cell with an air electrode is intended to be exposed during operation because the magnitude of the levelling effect of the hygroscopic material upon the water balance depends on its concentration. Preferably, the weight ratio of CaBr₂ to NaOH in an electrolyte is between 4:1 and 1:2.

An embodiment of the invention provides the use of the modified electrolyte in button cells. The anode for a button cell can be prepared from Zn powder with binding agents and gelling agents, and can be mixed with KOH or with some hygroscopic material. One method of production is described in patent application WO 2005/004260. The air electrode can be prepared from PTFE and activated carbon as described in patent application WO 2005/038967. A membrane separates the two electrodes. Set-up of the battery is showed in FIG. 10 which shows a cross-sectional view of a button cell design. The button cell has a battery case 101 which surrounds the cell. A zinc electrode 102 is located at one side and protruding from the battery case whilst an air electrode 103 is located at the other side of the battery case, adjacent an area 104 of the battery case that allows air access to the air electrode. Both dry and wet assembly of the button cell is possible. The electrolyte resides in the space between the electrodes 102 and 103 and also inside the pores of the zinc electrode 102 and partly inside the pores of the air electrode 103.

A further embodiment of the invention provides a button cell with modified electrolyte that can operate at low humidity without drying. The water balance in a battery with standard electrolyte is significantly influenced by the temperature and humidity of its surroundings. Introduction of hygroscopic material to the system causes the electrolyte to be less sensitive to fluctuations in the external temperature and humidity.

An embodiment of the invention provides a button cell with modified electrolyte that can operate for long periods of time both at open circuit potential (OCP) and under polarisation. This can be done without covering up the air access, contrary to what is customary in currently available commercial metal-air batteries.

Another embodiment provides that larger holes for oxygen access are used than would be possible without humidity management. This enables the battery to operate at higher currents without oxygen diffusion limitations and increased dry out rates. As an example, primary button cell (size 675) Zn-air batteries show diffusion limitation at about 30 mA due to the limited oxygen access. Opening the air access with a hole of 4.9 mm in diameter gives a current of more than 150 mA without diffusion limitations.

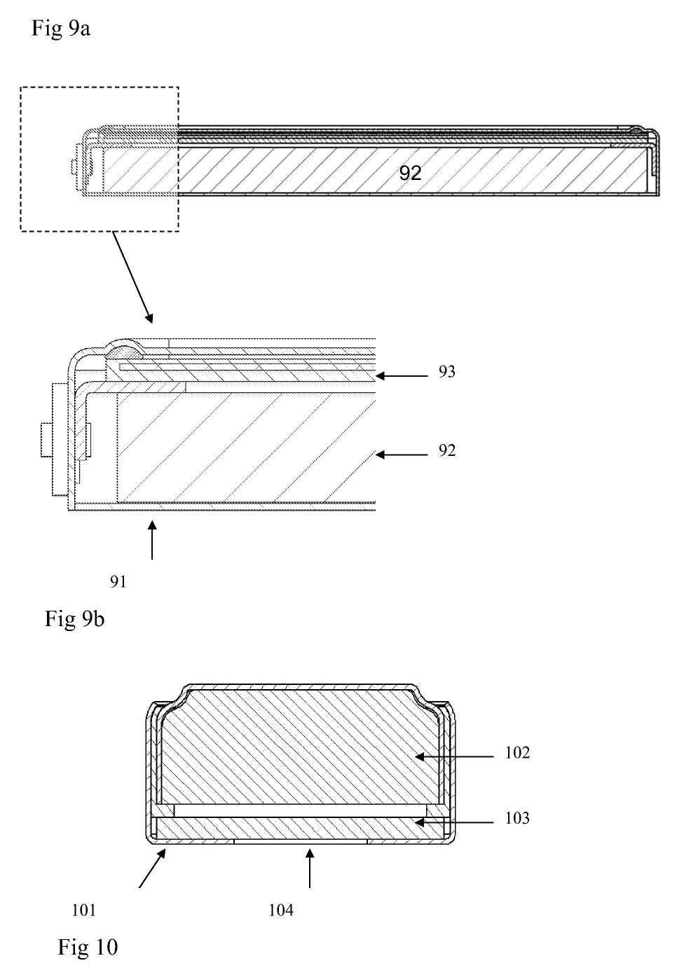

Another embodiment of the invention is the use of the modified electrolyte in a prismatic cell. The anode is prepared from Zn powder with binding agents and gelling agents, and can be mixed with KOH or with some hygroscopic material. One method of production is described in patent application WO 2005/004260. The air electrode can be prepared from PTFE and activated carbon as described in patent application WO 2005/038967. A membrane separates the two electrodes. A sketch of the battery set-up is shown in FIG. 9. FIG. 9a shows a cross-sectional view of a prismatic cell in which a zinc electrode 92 runs along the length of the cell. FIG. 9b shows an enlarged view of one end of the cell shown in FIG. 9a. FIG. 9b shows battery casing 91 surrounding the cell, zinc electrode 92 inside the casing together with the air electrode and current collector 93. The electrolyte resides in the space between the electrodes 92 and 93 and also inside the pores of the zinc electrode 92 and partly inside the pores of the air electrode 93. The upper part of the casing 91 contains holes for the air access (not shown in the sectional view).

The invention is further illustrated by the following examples.

### EXAMPLES

### Example 1

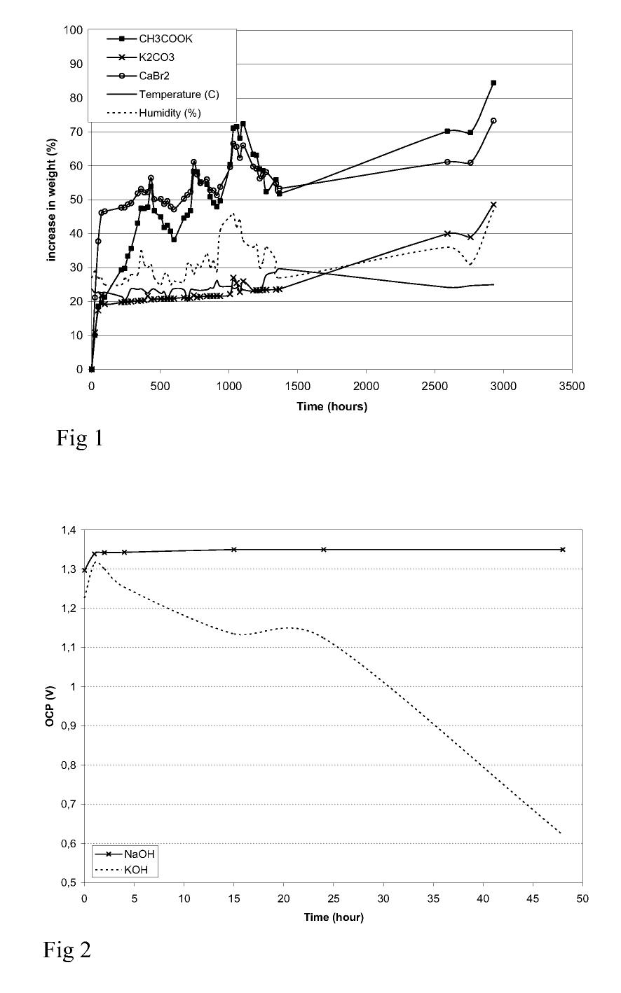

The water retaining properties were tested for the following hygroscopic salts: CH₃COOK, K₂CO₃ and CaBr₂. 1.000 g of each of the three powders was weighed out and placed in open glass containers. The samples were left at ambient conditions and weight measurements were performed once a day. The humidity and temperature were logged continuously. After 1-3 days it was observed that the powder slowly turned into a liquid as water was absorbed. The ability of the different powders to absorb water from the atmosphere is shown in FIG. 1. The curves show the increase in weight as a function of time for each of the powders. It was observed that CaBr₂ absorbed water from the atmosphere, and after two days the powder was completely dissolved in water. The increase in weight was almost 50%. A similar result was obtained with CH₃COOK and K₂CO₃, but it takes 10 days to have a similar increase in weight.

The example shows the amount of water absorbed into the hygroscopic powders. The example also shows that after the water is absorbed the formed liquid is in a stable state.

### Example 2

### Comparison

In the experiment two prismatic batteries with different alkaline electrolytes, NaOH and KOH, were studied. The anode of each cell was prepared with 6 g of Zn, 0.15 g of Carbopol 940 (Noveon), 0.15 g of PTFE powder with a particle size of 1 mm (Lawrence Industries) and 0.5 g of CaBr₂. The paste was made with the different electrolytes, and the polypropylene separator membrane was also soaked in each electrolyte. On top of the anode and separator an air electrode created according to assembly example 2 in the detailed description of the invention was added. The battery assembly is illustrated in FIG. 9 and described above. The cells were not completely sealed, with openings for the current collectors. The experiment was performed at ambient temperature and humidity.

The OCP was registered regularly for two days as shown in FIG. 2. Measurements of the OCP indicate an active electrode well wetted with the electrolyte.

It was observed that the cell with NaOH exhibited a stable OCP of 1.3V for the full duration of the experiment (48 hours). When the cell with NaOH was opened, the paste was still wet. The OCP of the cell with KOH as electrolyte was found to be less stable. After 2 hours the OCP starts to decrease indicating that the cell is drying out.

The example shows that NaOH is a more stable electrolyte in metal-air batteries than KOH.

### Example 3

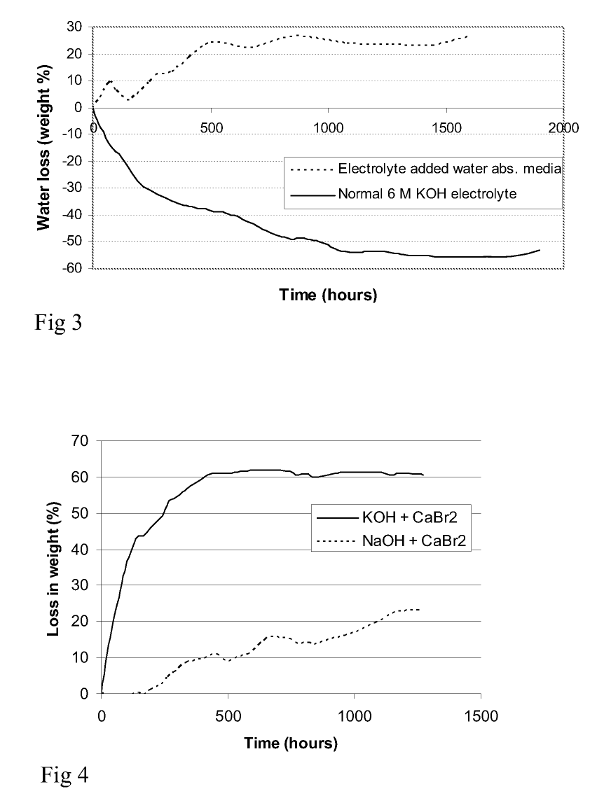

By adding a hygroscopic material to the electrolyte, the loss of water within the battery is reduced. A dry sample of 20% NaOH and 80% CaBr₂, 6 grams in total, was left in ambient air for about 1600 hours. As reference a sample of 30 g KOH solution (6 M) was used. Both samples were weighed regularly during the experiment. The percentage change in weight for the two samples is shown in FIG. 3 as a function of time. For the powder mixture of NaOH and CaBr₂ an increase in weight with time due to absorption of water from the air is shown. After about 1000 hours, however, the weight stabilises. This indicates that the powder is saturated with water and is in balance with the surroundings. For the KOH sample without any hygroscopic material, a decrease in weight through the complete period due to evaporation of water is shown.

The example shows that the cell with aqueous KOH dries out with time. The example also shows that the weight of the CaBr₂ and NaOH mixture remains stable after equilibrium of the water balance is reached.

### Example 4

The previous examples have demonstrated the water retaining properties of hygroscopic material. It has also been shown that NaOH is more stable than KOH with respect to the open circuit potential when combined with a hygroscopic material. In this example the water retaining properties of CaBr₂ in a KOH solution and CaBr₂ in a NaOH solution are tested.

Two samples were left open to ambient air: 0.5 g of CaBr₂ powder in 10 g of KOH (6.6 M) and 0.5 g of CaBr₂ powder in 10 g of NaOH (12 M-35%). The weight loss in of the samples was measured daily for ten days. The result of the weighing is shown in FIG. 4. A significant difference in terms of evaporation was observed during the test period of 1200 hours. An average 55% of water was lost in the KOH solution while only 25% was lost in the NaOH solution. This demonstrates that the water-binding properties of CaBr₂ are present in a NaOH solution, while it is strongly reduced in a KOH solution. The initial loss in weight for both electrolytes shows that the wet samples are oversaturated with water. Eventually the water balance reaches equilibrium and the weight stabilises. This equilibrium is at a higher water content with NaOH.

The experiment shows that the NaOH and CaBr₂ mixture has a slower water loss reaction and loses less water than the KOH and CaBr₂ mixture. NaOH gives an electrolyte less sensitive to external conditions when combined with hygroscopic material than KOH.

### Example 5

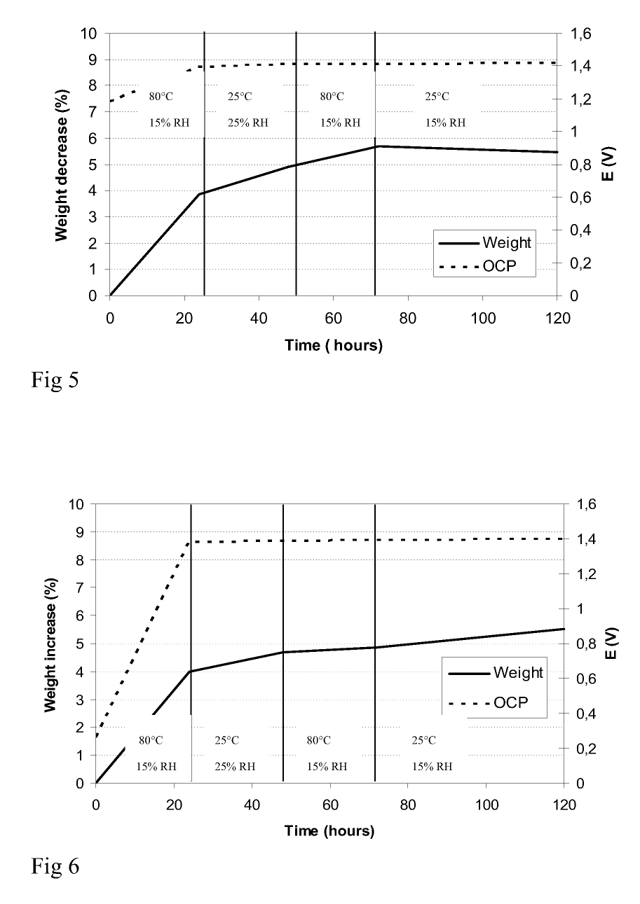

External conditions such as temperature and humidity influence the water balance within the cell. Weight loss and open circuit potential have been measured for a zinc-air button cell. The anode was prepared from Zn powder mixed with KOH solution and pasted into a button cell battery case. The air electrode was prepared according to assembly example 2 in the detailed description of the invention. A standard polypropylene separator soaked with electrolyte was used. The assembly is illustrated in FIG. 10 and described above. The electrolyte consists of 57 wt % of a powder mixture with a 1:1 weight ratio of CaBr₂ and NaOH and 43 wt % of H₂O. The experiment was performed in a climate chamber to be able to control the temperature and humidity. During the first 24 hours of the experiment the temperature was 80° C. and the relative humidity 15%. As shown in FIG. 5 (solid line and left axis), the weight of the wet assembled cell decreased by about 5 weight % in this period. The rapid weight loss can be explained by an oversaturated electrolyte. The following 24 hours of the experiment was carried out under ambient conditions, 25° C. and 25% humidity. The weight of the cell is still decreasing but at a slower rate, as expected. After this period equilibrium is reached and the weight is stable. In fact, even though, in the 48^{th} hour of the experiment, the temperature was raised to 80° C. and the humidity was lowered to 15% the weight of the cell was not influenced. In the fourth period of the experiment the temperature was 25° C. and the relative humidity 15%. The right axis and dotted line of FIG. 5 shows the OCP of the cell. During the first period of the experiment, the OCP increases as excess water in the electrolyte is vaporising. After about 20 hours it is at 1.4 V and stays stable for the rest of the experiment.

The experiment shows that when a wet mixture of NaOH and CaBr₂ is used as electrolyte, no drying out of the cell occurs.

### Example 6

This example shows the influence of the external conditions on full cells for other hygroscopic material. A dry mixture of 0.1 g K₃PO₄ powder and 0.1 g NaOH powder was used as electrolyte. The anode was prepared from Zn powder mixed with KOH solution and pasted into a button cell battery case. The air electrode was prepared according to assembly example 2 in the detailed description of the invention. A standard polypropylene battery separator was used. The assembly is illustrated in FIG. 10 and described above. FIG. 6 gives the weight increase and the OCP for the cell as a function of time. During the first 24 hours of the experiment the temperature was 80° C. and the relative humidity 15%. The weight of the cell increases in this period because the electrolyte powder mixture is taking up water from the atmosphere. The following 24 hours of the experiment was carried out under ambient conditions, 25° C. and 25% humidity. The weight of the cell is still increasing but at a slower rate. In the following periods the external conditions are adjusted to 80° C. and 15% relative humidity for 24 hours and then 25° C. and 15% relative humidity. The weight of the cell stabilizes over this period and is not influenced by the change in the external condition. At the beginning of the experiment the OPC is low and increases as the cell is being activated by the liquefying of the electrolyte. A stable OPC of 1.4 V is obtained after about 20 hours and stays stables throughout the duration of the experiment and is hence not influenced by the external climate.

The experiment confirms that hygroscopic powder in combination with NaOH powder prevents drying out of the cell. The experiment also shows that this is valid for high temperature and low humidity. Finally, the experiment shows that not only CaBr₂ but also other water absorbing materials like K₃PO₄ can be used to retain water within the system of the cell.

### Example 7

Introducing hygroscopic material to the electrolyte prevents drying out of the battery, even in low humidity conditions. To ensure that this is valid over longer periods, the potential of a button cell was measured for 1000 hours at a current of 0.16 MA, 0.92 mA/cm² of exposed air area.

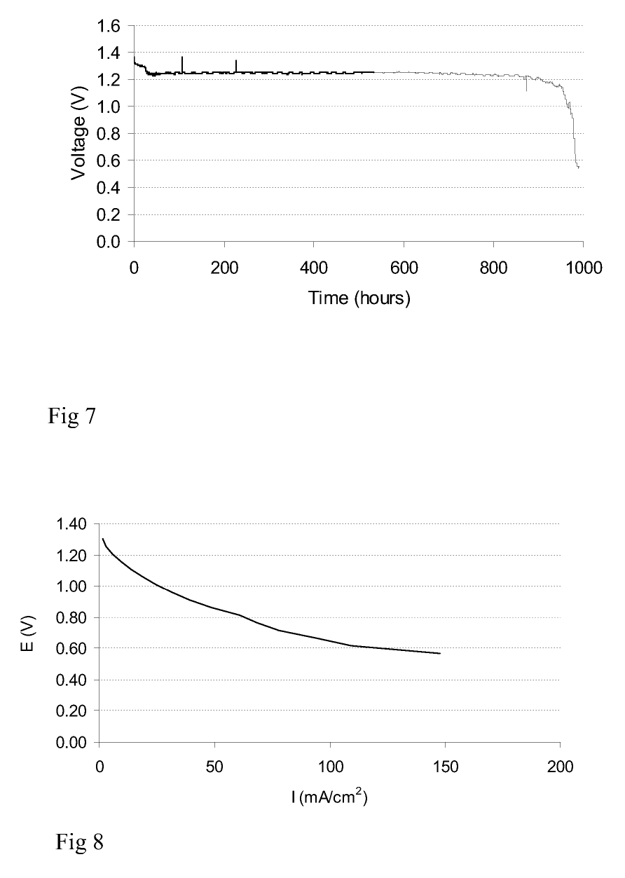

The anode of the cell was prepared from 1 gram of a powder mixture of Zn and Carbopol 940 (Noveon) and made into a paste by mixing in KOH. The anode material was pasted into the battery case and a polypropylene separator wetted with electrolyte was placed on top. The electrolyte was prepared from 57 wt % of a powder mixture with a 1:1 weight ratio of CaBr₂ and NaOH and 43 wt % of water. The air electrode was prepared according to assembly example 2 in the detailed description of the invention and was placed on top of the membrane. The assembly of the battery is illustrated in FIG. 10 and described above. FIG. 7 shows the potential in a wet assembled button cell with hygroscopic material as a function of time. The potential remains stable at 1.25 V. The experiment shows a cell with wet electrolyte of NaOH and CaBr₂ does not dry out throughout the period of the experiment, 1000 hours.

### Example 8

An experiment was performed in order to demonstrate the influence of the current density on the potential for a half cell with NaOH and CaBr₂ as electrolyte. The air electrode was prepared according to assembly example 2 in the detailed description of the invention; a Ni-mesh was used as counter electrode and a Zn-wire as reference electrode. The electrolyte was prepared from 10 g CaBr₂ and 10 g NaOH dissolved in 15 ml H₂O. The test was carried out at ambient temperature and relative humidity and the current and potential was logged through the 40 hours experiment.

FIG. 8 shows the polarisation curve of the experiment. The experiment shows that high ionic activity for the air electrode is obtained with the new electrolyte

1. A metal-air battery or fuel cell comprising a metal or metal hydride anode, an aqueous liquid electrolyte containing an ion conducting material, and an air electrode which allows ingress and egress of oxygen and which contains one or more catalysts capable of evolution and/or reduction of oxygen, wherein the air electrode has both hydrophobic and hydrophilic pores, the hydrophilic pores are at least partially filled with aqueous liquid electrolyte and the air electrode and/or the electrolyte comprises hygroscopic material and OH⁻ ions, whereby water vapour exchange with the environment is limited.

2. A metal-air battery or fuel cell according to claim 1 wherein the hygroscopic material comprises CaBr₂, K₃PO₄, CH₃COOK, K₂CO₃, K₂HPO₄, KH₂PO₄, Na₂SO₄, MgSO₄, P₄O₁₀, CaO, CaCl₂, or combinations thereof.

3. A metal-air battery or fuel cell according to claim 1 wherein the OH⁻ ions are in the form of NaOH, KOH and/or LiOH.

4. A metal-air battery or fuel cell according to claim 1 wherein the OH⁻ ions are in the form of NaOH and the hygroscopic material is CaBr₂.

5. A metal-air battery or fuel cell according to claim 4 wherein the CaBr₂ and NaOH are present in a weight ratio between 4:1 and 1:2, for example 1:1.

6. A metal-air battery or fuel cell according to claim 1 wherein the hydrophobic pores are pores which are rendered hydrophobic by a complete or partial coating of the walls of said pores with a polymer selected from PTFE, polyolefins, thermoplastics, polyamides, polyvinylidene fluoride, silicone-based elastomers, rubber materials, or combinations thereof.

7. A metal-air battery or fuel cell according to claim 1 wherein the hydrophilic pores are pores situated within an activated carbon or graphite material or a combination thereof.

8. A metal-air battery according to claim 1 which is a secondary battery.

9. Method for controlling the humidity of a metal-air battery or fuel cell system comprising a metal or metal hydride anode, an aqueous liquid electrolyte and an air electrode that takes oxygen from the environment as cathode, which comprises providing hygroscopic material and OH⁻ ions in the air electrode and/or the electrolyte.

10. Method according to claim 9 wherein the air electrode has both hydrophobic and hydrophilic pores and contains one or more catalysts capable of evolution and/or reduction of oxygen and wherein the air electrode and/or the electrolyte contains OH⁻ ions and a hygroscopic material and the hydrophilic pores are at least partially filled with electrolyte.

11. Method according to claim 9 wherein the hygroscopic material comprises CaBr₂, K₃PO₄, CH₃COOK, K₂CO₃, K₂HPO₄, KH₂PO₄, Na₂SO₄, MgSO₄, P₄O₁₀, CaO, CaCl₂, or combinations thereof.

12. Method according to claim 9 wherein the OH⁻ ions are in the form of NaOH, KOH and/or LiOH.

13. Method according to claim 9 wherein the OH⁻ ions are in the form of NaOH and the hygroscopic material is CaBr₂.

14. Method according to claim 13 wherein the CaBr₂ and NaOH are present in a weight ratio between 4:1 and 1:2, for example 1:1.

15. Method according to claim 10 wherein the hydrophobic pores are pores which are rendered hydrophobic by a complete or partial coating of the walls of said pores with a polymer selected from PTFE, polyolefins, thermoplastics, polyamides, polyvinylidene fluoride, silicone-based elastomers, rubber materials, or combinations thereof.

16. Method according to claim 10 wherein the hydrophilic pores are pores situated within an activated carbon or graphite material or a combination thereof.

17. Use of a hygroscopic material and OH⁻ ions in the air electrode and/or the electrolyte of a metal-air battery or fuel cell system to control the humidity of the system.

18. Method for the dry assembly of a metal-air battery or fuel cell comprising an air electrode that takes oxygen from the environment as cathode, a metal or metal hydride anode, and an electrolyte, said method comprising assembling the cathode, anode and a dry powder mixture of hygroscopic material and a source of OH⁻ ions to form the battery and allowing the powder mixture to self-activate by absorbing water from the air thereby forming an ionic conductive aqueous electrolyte.

19. Method according to claim 18 wherein the metal-air battery or fuel cell is as defined in claim 1.

20. Method for the wet assembly of a metal-air battery or fuel cell comprising an air electrode that takes oxygen from the environment as cathode, a metal or metal hydride anode, and an electrolyte, which comprises the steps of:
dissolving a hygroscopic powder in an aqueous solution containing OH⁻ ions to form an electrolyte solution;
adjusting the pH of the electrolyte solution such that it is equivalent to an alkaline solution with a 2-12 M OH⁻; and
assembling the cathode, anode and electrolyte solution to form the battery.

21. Method according to claim 20 wherein the metal-air battery or fuel cell is as defined in claim 1.

22. Method for reactivating a dry metal-air battery or fuel cell comprising an air electrode that takes oxygen from the environment as cathode, a metal or metal hydride anode, and an electrolyte comprising hygroscopic material and OH⁻ ions, said method comprising exposing the battery to a humid environment whereby the dry electrolyte self-activates by absorbing water from the air thereby forming an ionic conductive aqueous electrolyte.

23. Method according to claim 22 wherein the metal-air battery or fuel cell is as defined in claim 1.

24. A metal-air battery or fuel cell comprising an air electrode that takes oxygen from the environment as cathode, a metal or metal hydride anode, and an electrolyte, wherein the electrolyte comprises CaBr₂ as hygroscopic material and NaOH as a source of OH⁻ ions.

25. A metal-air battery or fuel cell according to claim 24 wherein the CaBr₂ and NaOH are present in a weight ratio between 4:1 and 1:2, for example 1:1.

26. A metal-air battery or fuel cell comprising an air electrode that takes oxygen from the environment as cathode, a metal or metal hydride anode, and an electrolyte, wherein the air electrode comprises CaBr₂ as hygroscopic material and NaOH as a source of OH⁻ ions.

27. A metal-air battery or fuel cell according to claim 26 wherein the CaBr₂ and NaOH are present in a weight ratio between 4:1 and 1:2, for example 1:1.
